(19) United States
(12) Patent Application Publication
(10) Pub. No.: US 2026/0368853 A1
(43) Pub. Date: Nov. 19, 2026

(54) SYSTEMS AND METHODS FOR NOISE REDUCTION IN CONVERGENT POCS RECONSTRUCTED DATA

(71) Applicant: SAUDI ARABIAN OIL COMPANY, Dhahran (SA)

(72) Inventors: Yimin Sun, Den Haag (NL); Miaoyang Yuan, Delft (NL)

(73) Assignee: ARAMCO OVERSEAS COMPANY B.V., The Hauge (NL)

(21) Appl. No.: 19/208,800

(22) Filed: May 15, 2025

(51) Int. Cl. G06T 5/20; G06T 5/10; H04N 5/74

(52) U.S. Cl. CPC G06T 5/20; G06T 5/10; H04N 5/74

(57) ABSTRACT

Systems and methods for noise reduction in convergent POCS reconstructed data are disclosed. The methods include obtaining an input image, initializing initial values of an intermediate image, and creating a sequence of thresholding values. While a total number of iterations has not been reached the methods further include applying a filter to the intermediate image and, while a convergence condition is not met, projecting the intermediate image onto a first convex set by transforming the intermediate image, applying a muting mask, and inverse-transforming the intermediate image. The methods further include projecting the intermediate image on a second convex set, which requires reinserting data points from the input image in a corresponding location in the intermediate image. When the total number of iterations has been reached, the methods include recording the intermediate image as a reconstructed output image and interpreting features of the reconstructed output image to make an operational decision.

### BACKGROUND

The alternating projections onto convex sets (POCS) method is a procedure for data reconstruction, particularly in the field of seismic data processing. Convergent POCS (CP) methods exist but the results from these methods may have residual ringing noise that detract from their effectiveness

A new method is desired that suppresses ringing noise while improving reconstruction quality in a computationally efficient way.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to methods for noise reduction in convergent POCS reconstructed data. The methods include obtaining an input image, initializing initial values of an intermediate image, and creating a sequence of thresholding values. While a total number of iterations has not been reached, the methods further include applying a filter to the intermediate image and, while a convergence condition is not met, projecting the intermediate image onto a first convex set by transforming the intermediate image, applying a muting mask, and inverse-transforming the intermediate image. The methods further include projecting the intermediate image on a second convex set, which requires reinserting data points from the input image in a corresponding location in the intermediate image. When the total number of iterations has been reached, the methods include recording the intermediate image as a reconstructed output image and interpreting features of the reconstructed output image to make an operational decision.

In one aspect, embodiments disclosed herein relate to a non-transitory computer readable medium storing instructions executable by a computer processor that, when executed on a processor, cause the processor to perform the steps of noise reduction in convergent POCS reconstructed data. The steps include initializing initial values of an intermediate image, creating a sequence of thresholding values, and, while a total number of iterations has not been reached, applying a filter to the intermediate image, and, while a convergence condition is not met, projecting the intermediate image onto a first convex set by transforming the intermediate image, applying the muting mask, and inverse-transforming the intermediate image. The steps further include projecting the intermediate image on a second convex set, wherein the projection onto the second convex set requires reinserting data points from the input image in a corresponding location in the intermediate image. The steps further include, when the total number of iterations has been reached, recording the intermediate image as a reconstructed output image and interpreting features of the reconstructed output image to make an operational decision.

In one aspect, embodiments disclosed herein relate to systems for noise reduction in convergent POCS reconstructed data. The system includes an input image and a computer system configured to initialize initial values of an intermediate image, create a sequence of thresholding values, and, while a total number of iterations has not been reached, apply a filter to the intermediate image, use the sequence of thresholding values to update a muting mask, and, while a convergence condition is not met, project the intermediate image onto a first convex set, wherein the projection onto the first convex set requires transforming the intermediate image, applying the muting mask, and inverse-transforming the intermediate image. The computer system is further configured to project the intermediate image on a second convex set, wherein the projection onto the second convex set requires reinserting data points from the input image in a corresponding location in the intermediate image, and, when the total number of iterations has been reached, recording the intermediate image as a reconstructed output image and interpreting features of the reconstructed output image to make an operational decision.

Other aspects and advantages of the claimed subject matter will be apparent from the following description and the appended claims.

### BRIEF DESCRIPTION OF DRAWINGS

FIG. 1 is a flowchart, in accordance with one or more embodiments.

FIG. 2 is a schematic, in accordance with one or more embodiments.

FIG. 3 is a flowchart, in accordance with one or more embodiments.

FIG. 4 is a schematic, in accordance with one or more embodiments.

FIG. 5 is an image, in accordance with one or more embodiments.

FIG. 6 is an image, in accordance with one or more embodiments.

FIG. 7 is an image, in accordance with one or more embodiments.

FIG. 8 is an image, in accordance with one or more embodiments.

FIG. 9 is an image, in accordance with one or more embodiments.

FIG. 10 is an image, in accordance with one or more embodiments.

FIG. 11 is an image, in accordance with one or more embodiments.

FIG. 12 is an image, in accordance with one or more embodiments.

FIG. 13A is an image, in accordance with one or more embodiments.

FIG. 13B is an image, in accordance with one or more embodiments.

FIG. 13C is an image, in accordance with one or more embodiments.

FIG. 13D is an image, in accordance with one or more embodiments.

FIG. 14 is a workflow of a method, in accordance with one or more embodiments.

FIG. 15 is a computer system, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

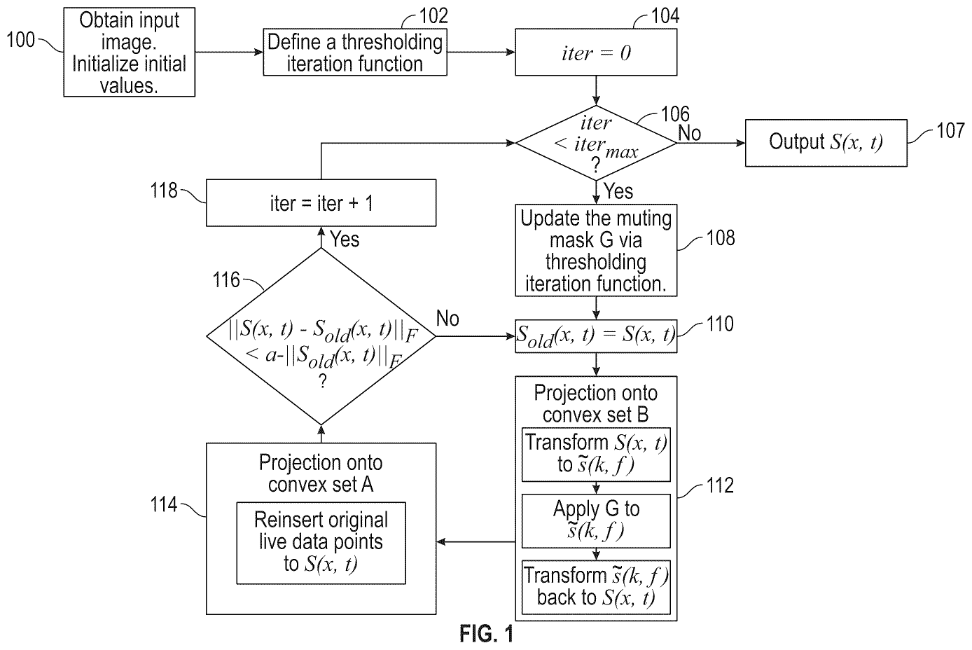

In the following description of FIGS. 1-15, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “Gaussian filter” includes reference to one or more of such Gaussian filters.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

The CP method has found successful applications in various domains, including seismic data reconstruction, seismic model reconstruction, and general image reconstruction. Despite its success, a drawback of the CP method is ringing noise in the reconstructed result, a common issue encountered in many POCS methods.

In general, embodiments of the disclosure include a system and a method to integrate a Gaussian filter into a CP method in a way that continuously refines intermediate reconstructions and produces an output image in a computationally efficient manner with less ringing than conventional methods. In particular, embodiments describe the application of the method to seismic data. The seismic data may be in the time domain or in the depth domain. However, for the examples presented below, it is assumed that the seismic data is in the time domain.

In the embodiments presented below, the primary mathematical operations used by the CP method in its projections onto convex set include: re-inserting known data at pre-defined data locations; forward transforming data to the k-domain using Fourier transforms, applying a pre-calculated mask pattern to the k-domain data, and transforming the k-domain data back to the data domain via inverse Fourier transforms. Fourier transforms may make the CP method highly suitable for real-time data-reconstruction tasks powered by edge computing. However, Fourier transforms are not the only option for transforming the data in this method. Other data transforms such as, e.g., wavelet transforms or Laplace transforms, may be used. Projection into an over-complete set of functions may also be used for transforming the data to an alternate domain.

CP may be categorized within the family of POCS methods. In mathematical terms, a POCS method comprises several key components. First, initial values serve as the starting point for the projection process. The initial values may be set once at the beginning of the projection process, with the to-be reconstructed data typically initialized to 0s.

Second, convex sets may be defined by:

A={u(x,y)|u(x,t)=v(x,y) for predefined(x,y)locations},u,v∈R², (1)

B={u(kₓ,kₓ)|u(kₓ,kₓ)=0 for predefined(kₓ,kₓ)locations},u∈C² (2)

where A is a set of mappings u(x,y) (the intermediate image) such that u(x,y) is equal to v(x,y) (the input image) at predefined (x,y) locations with, in the case of a time-domain seismic image, x and y representing the spatial and temporal coordinate, and u(x,y) and v(x,y) being in the real number domain. B is a set of u(kₓ,kₓ) such that u(kₓ,kₓ) is equal to 0 at predefined (kₓ,kₓ) locations, kₓ and kₓ represent frequencies along the respective axes, and u(kₓ,kₓ) is in the complex number domain; the vertical bar “|” in the equation means “such that”.

Third, a projection operation, whose mathematical specifics are contingent upon the particular convex set defined above. Projection onto B may be done by transforming, muting, and then inverse-transforming, where the muting operation sets certain data values to zero:

$${P}_{B} ( u ( x , y ) ) = {F}_{y}^{- 1} {F}_{x}^{- 1} {GF}_{x} {F}_{y} u , \qquad ( 3 )$$

$$G ( {k}_{x} , {k}_{y} ) = \{ \begin{matrix}1 , & \begin{matrix}for predefined locations related \\ to the thresholding value {p}_{k}\end{matrix} \\ 0 , & otherwise\end{matrix} , {p}_{k} ∈ p , \qquad ( 4 )$$

where u(x,y) is the input signal; v(x,y) is the known signal at the known (x,y) locations. p is a set of non-increasing non-negative thresholding values, i.e., p={p₁, p₂, . . . , p_{N}} and p₁≥p₂ . . . ≥p_{N}≥0, and N is the total number of thresholding iterations; F_{y} or Fₓ is the Fourier transform in the time or spatial domain; G is a thresholding mask with its components G (kₓ,kₓ) defined in Equation 4.

The muting mask G is calculated using a dataset s(x, t) and the thresholding value pₖ, both of which are available before entering the inner loop of projections onto convex sets A and B in the CP method. Elements in the muting mask G are calculated as:

$$G ( {k}_{x} , {k}_{y} ) = \{ \begin{matrix}1 , & if \vert \{ {F}_{x} {F}_{y} s ( x , t ) \} ( {k}_{x} , {k}_{y} ) \vert \geq {p}_{k} \\ 0 , & otherwise\end{matrix} .$$

Projection onto A may be done in the following way.

$${P}_{A} ( u ( x , t ) ) = \{ \begin{matrix}s ( x , y ) , & if ( x , y ) is a known trace location \\ u ( x , y ) , & otherwise\end{matrix} , \qquad ( 5 )$$

The order of the projections may be reversed, i.e., the image may be first projected onto set A, then onto set B.

Fourth, a convergence condition may be used to determine whether the alternating projections has reached a result close enough to the ideal mathematical convergent result. This may involve a comparison of the intermediate image before and after projection onto convex sets. The aim is to produce a final output image that lies in the intersection of these convex sets.

A flowchart of the CP method is presented in FIG. 1 that shows the four key components, along with intermediate steps. In Step 100, an input image is obtained. The input image is used to define the intermediate image as well. The intermediate image, s(x,y), begins as the input image with missing data values initialized to predetermined values, but undergoes gradual modifications through the CP method. The input image may be from any source, such as, e.g., a seismic image. The seismic image may be in depth or time. In the case of time-domain seismic data, the y coordinate is time. In the case of depth-domain seismic data, the y coordinate is depth.

In the embodiments shown herein, the images are two-dimensional. However, this is not a limitation of the method. The images may be of higher dimensions. Higher-dimensional images would only require that any data transformations be done in higher dimensions. This is not a limitation, as commonly used signal processing transformations (such as, e.g., Fourier transform, wavelet transforms, etc.) can be generalized to arbitrarily high dimensions.

In Step 102, the thresholding coefficients are defined. The thresholding coefficients describe a sequence of non-increasing values with the size of the sequence is equal to the total number of iterations, wherein a different value of the sequence is applied at each iteration of the CP method. For each particular iteration, the value of the sequence determines a set of data points in the transformed domain that are set to zero. In the case of Fourier transforms, this set of values correspond to those frequencies whose value lies below the value of the thresholding coefficient. As the iterations proceed, the threshold determines a smaller group of coefficients in the transformed domain, thus gradually allowing more and more details into the image.

In Step 104, the iteration counter is set to 0. In Step 106, a logical test is performed to determine if the number of iterations has reached a predefined maximum. If it has, the flowchart branches to Step 107, where the output image is finalized. If the iteration limit has not been reached, the flowchart proceeds to Step 108, where the thresholding mask based on the thresholding coefficients is created. The thresholding mask mutes out values in the transformed domain that are below the threshold. The thresholding mask will be applied below in Step 112.

In Step 110, the current intermediate image is stored as the “old” intermediate image, to be compared with the intermediate image after projection onto convex sets. In Step 112, the projection onto convex set B is performed. This is where the intermediate image is transformed into another domain, the thresholding mask is applied, and the result is inverse-transformed.

In Step 114, the projection onto convex set A is performed. This involves reinserting the original data points from the input image back into the intermediate image (i.e., reinserting data from the input image everywhere except at locations that did not have data to begin with).

In Step 116, a logical condition is checked. The Frobenius norm of the difference between the intermediate image and the old intermediate image is measured. This difference is checked to see if its value is less than the Frobenius norm of the old intermediate image alone, times a predetermined constant. If this check is passed, the flowchart proceeds to Step 118. If not, it returns to Step 110, where the old intermediate image is updated to equal the current intermediate image, and then projection onto convex sets is performed again in Steps 112 and 114.

Step 116 represents the return fork for an inner loop of the CP method. This loop will repeat until the Frobenius norm of the difference between the intermediate image and the old intermediate image is small enough. It should be noted that the norm need not be the Frobenius norm. Indeed, any norm may be used without changing the essence of the method. However, the CP method requires a norm that can be extended to an arbitrarily high-dimensional domain, as the CP method is not limited to the 2D domain. Not every other norm possesses this mathematical property of the Frobenius norm.

Once the check in Step 116 is passed, the flowchart proceeds to Step 118, where the iteration counter is incremented by one. The flowchart then proceeds to step 106 again, where a check is made to see if a maximum number of iterations has been reached. If so, the method proceeds to Step 107 and terminates. If not, the method proceeds to Steps 108, 110, 112, 114, and 116 again.

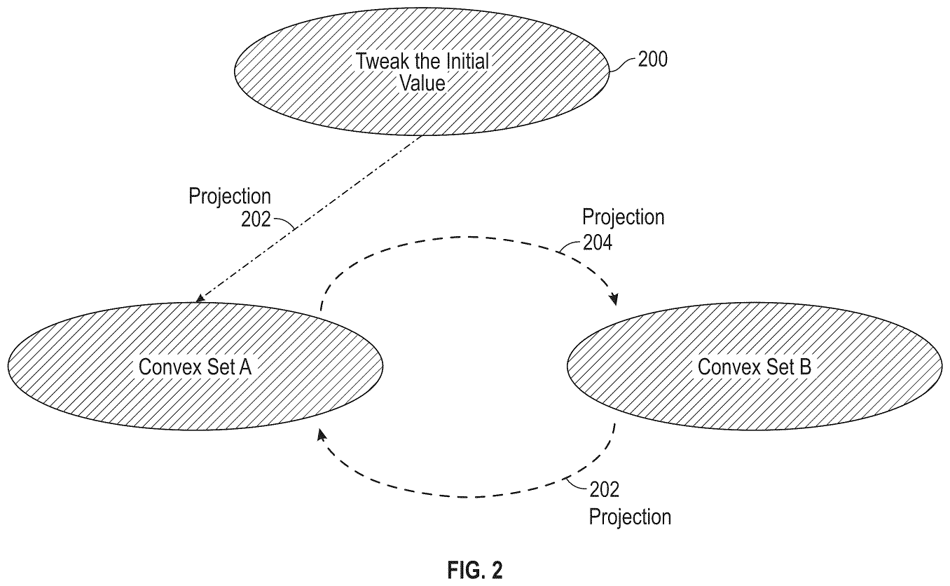

From a mathematical standpoint, the logic of the CP method is illustrated in FIG. 2, which shows that the initial input image is modified, or “tweaked,” only once in a preliminary modification (200) before projections onto convex sets. Beyond that point, the iterations of the algorithm only modify the image through projection onto convex set A (202) and projection onto convex set B (204). Each projection operation utilizes the previously projected value as its starting point and proceeds with the projection process. While this approach is mathematically straightforward, it comes with a consequence: a significant degree of control over the projection process is lost. Consequently, some reconstruction artifacts may be present in the output image. For instance, the ringing noise that is often observed in applications of CP may be attributed to this approach.

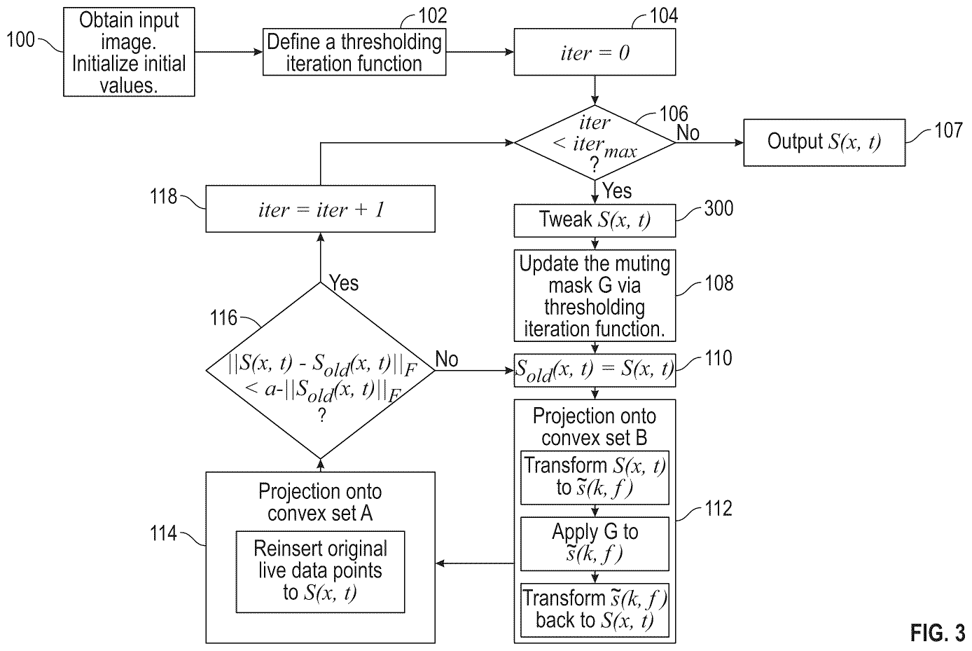

A novel method to mitigate the ringing noise observed in CP-reconstructed results is outlined in the flowchart in FIG. 3. This flowchart is identical to that of FIG. 1 apart from Step 300, where the intermediate image is “tweaked.” In this case, the tweaking involves filtering the intermediate image before projecting it onto convex sets. In contrast to the conventional CP method, within the outer loop of the novel method, the intermediate image undergoes value tweaking before updating the mask G required for the projection operation associated with the convex set B. In this flowchart, when the intermediate image, s(x,y), is tweaked, it influences and the reconstructed values (where data was missing from the input image) up to that point.

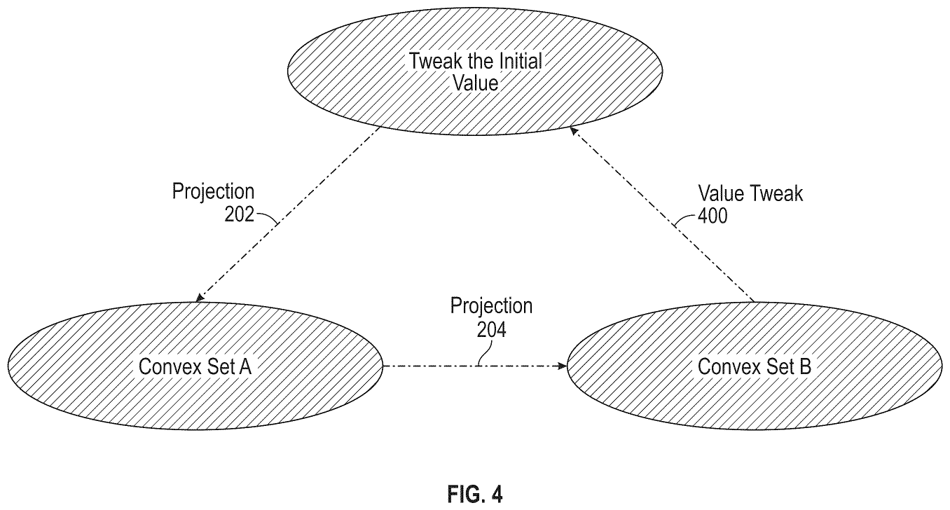

Unlike the conventional CP method, the novel modified method actively integrates iterative adjustments to the initial values (from the input image) as part of the algorithm. This is not done during the projections onto sets A and B. This filtering/tweaking process exerts control over the solution, guiding it towards a more favorable outcome in terms of data reconstruction quality. The basic idea is represented in FIG. 4, where the new tweaking operation (400) is inserted between each application of the projections onto convex sets A and B.

In the new method, there are various options for filtering/tweaking the intermediate image s(x,y). Potential candidate operations may include Gaussian filtering, non-local means denoising, anisotropic filtering, etc. Both Gaussian filtering and non-local means denoising are used in the examples presented below, but any filtering method may be used.

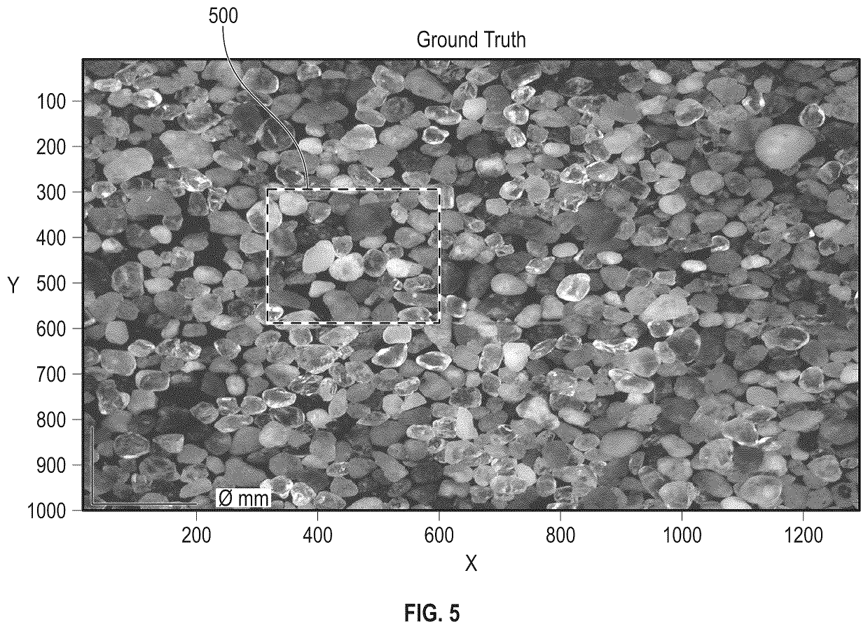

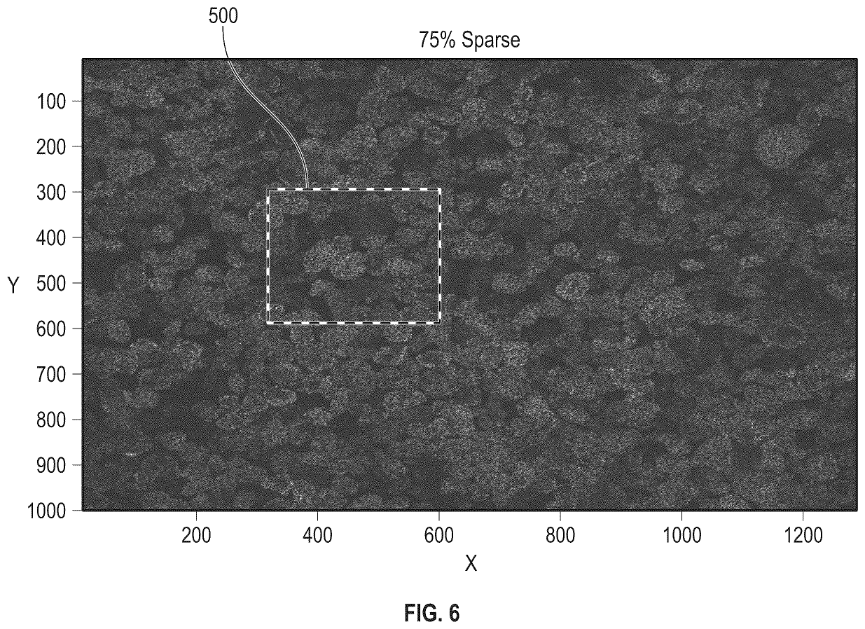

2D gray images of drill cuttings are utilized as a first example to illustrate the effectiveness of the novel method. FIG. 5 displays the image which serves as the ground truth. FIG. 6 showcases the sparse input image, v(x,y), utilized for the reconstruction tests, where 75% of the original data points depicted in FIG. 5 have been randomly deleted.

To compare the CP method and the novel method, the following parameters are employed: The total number of outer loop iterations is fixed at 20. A convergence ratio, a, is used in the inner loop, and is set to 0.01. For the demonstration, the novel method of tweaking the intermediate image s(x,y) involves convolving each data point with a 3×3 square Gaussian filtering kernel characterized by a standard deviation of 0.5.

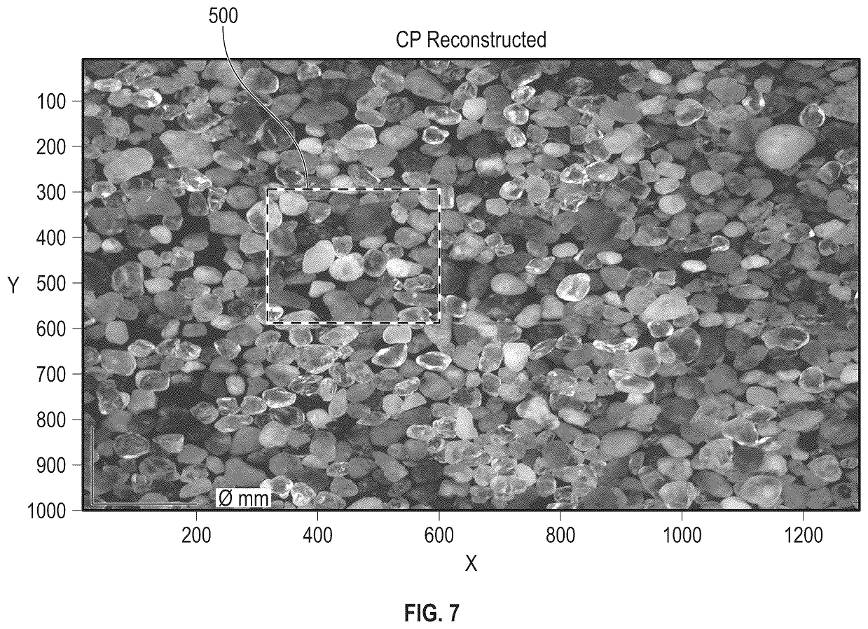

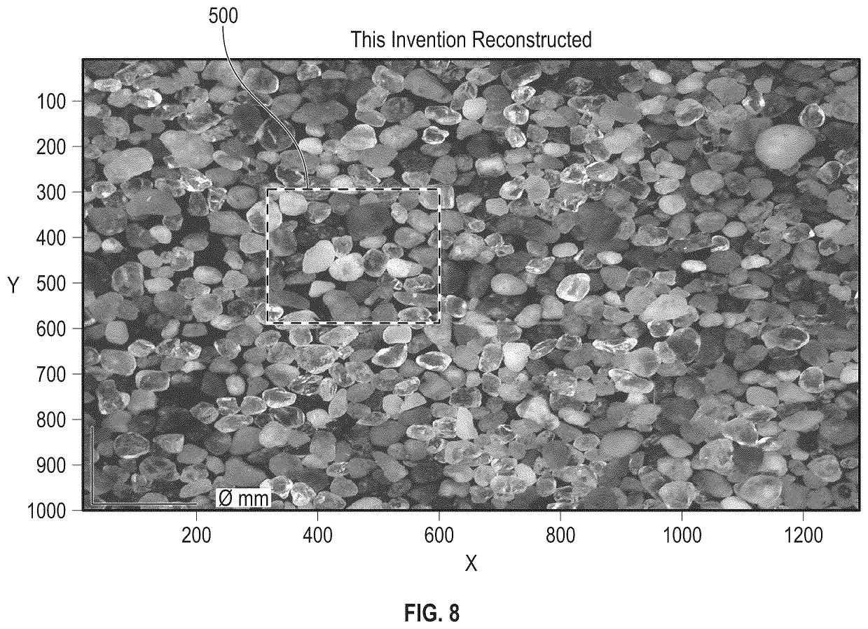

FIGS. 7 and 8 present the reconstructed results obtained from the CP method and the novel method, respectively. In FIG. 7, the presence of ringing noise is evident, as the overall image appears coarse and rugged. Conversely, the result reconstructed by the novel method, depicted in FIG. 8, exhibits a much smoother and sharper appearance. Additionally, boundaries between drill cuttings may be better resolved in the output obtained through the novel method.

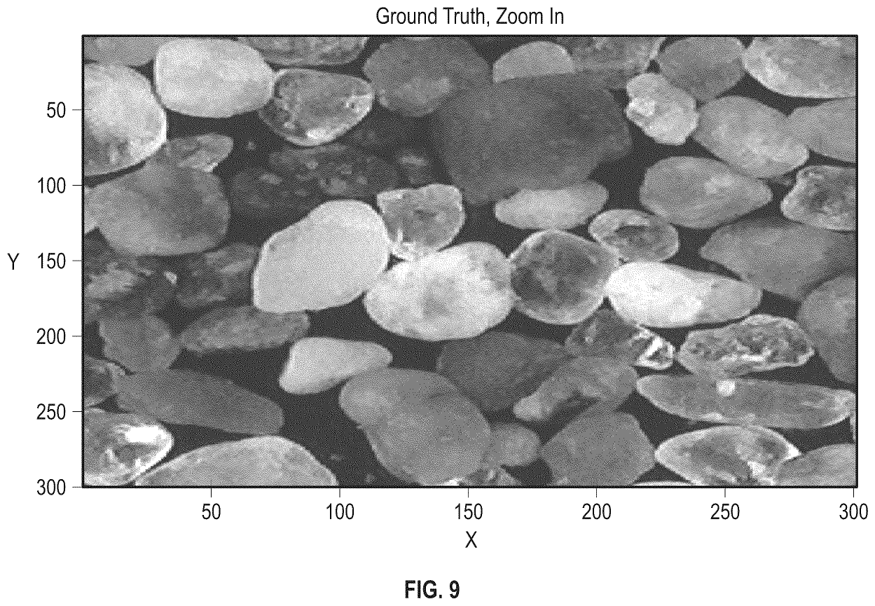

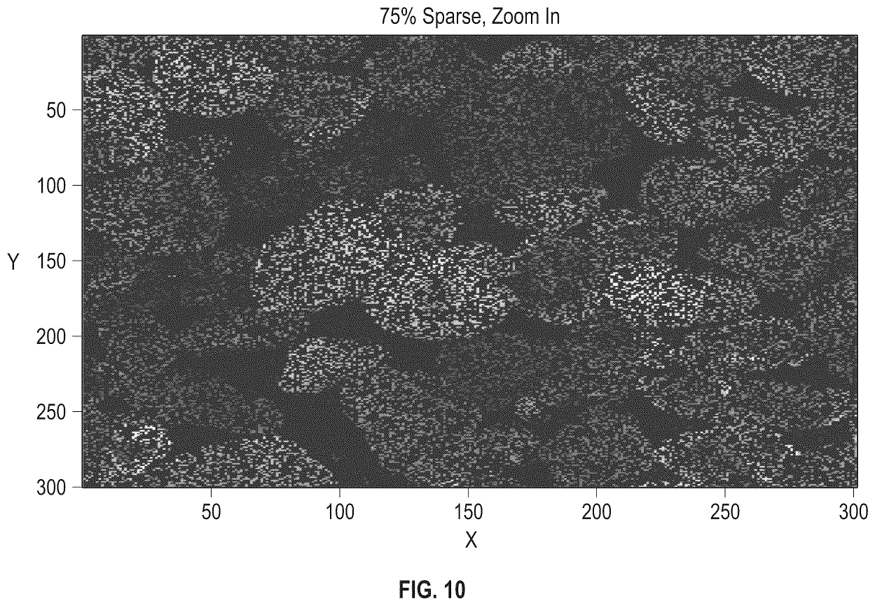

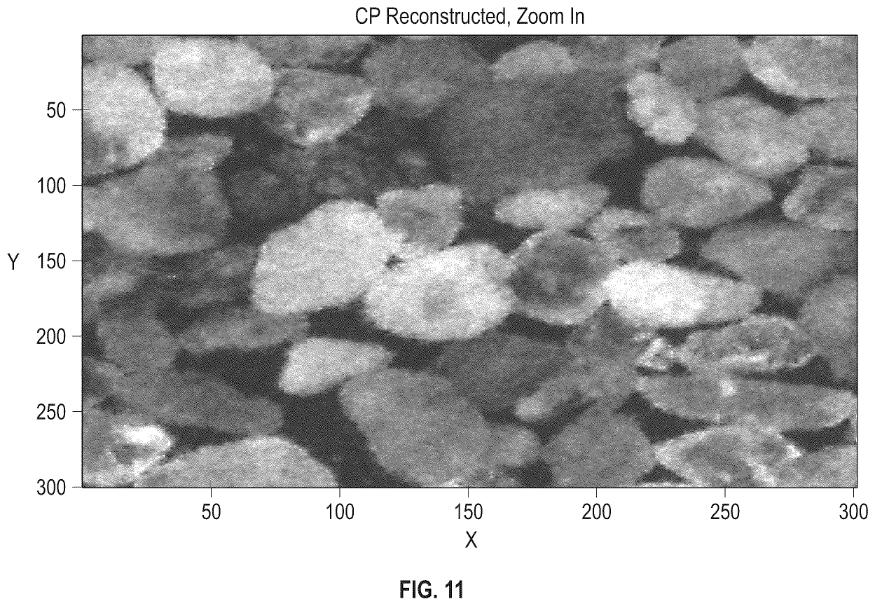

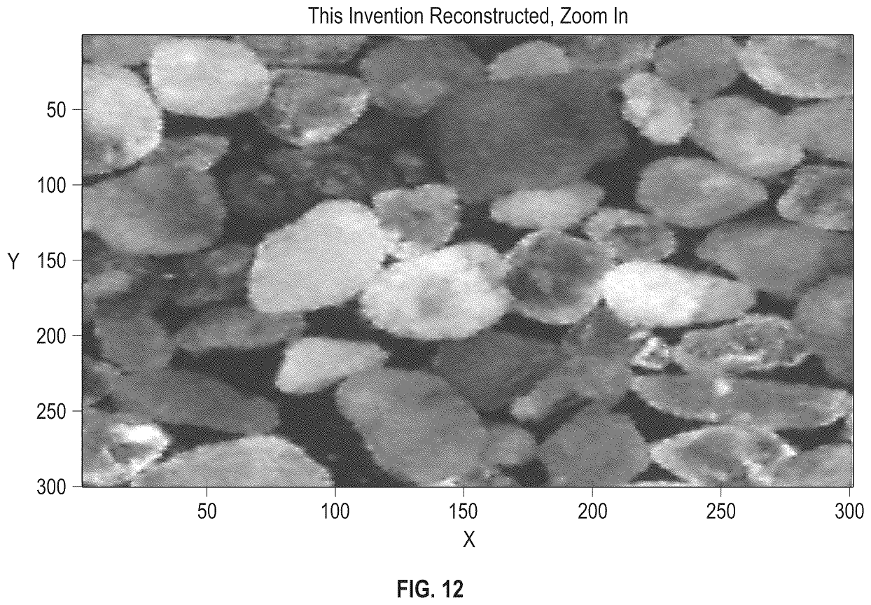

The area outlined by the red box (500) in FIGS. 5 through 8 is magnified in FIGS. 9 to 12. FIG. 9 shows a close-up view of the ground truth. FIG. 10 shows a close-up view of the input image. FIGS. 11 and 12 show close-up views of the conventional CP solution and the novel CP solution, respectively. In the close-up views of the images, it may be seen that there is less ringing in FIG. 12 than in FIG. 11. Thus, the novel CP method outperforms and produces higher-quality reconstruction results compared to the conventional CP method.

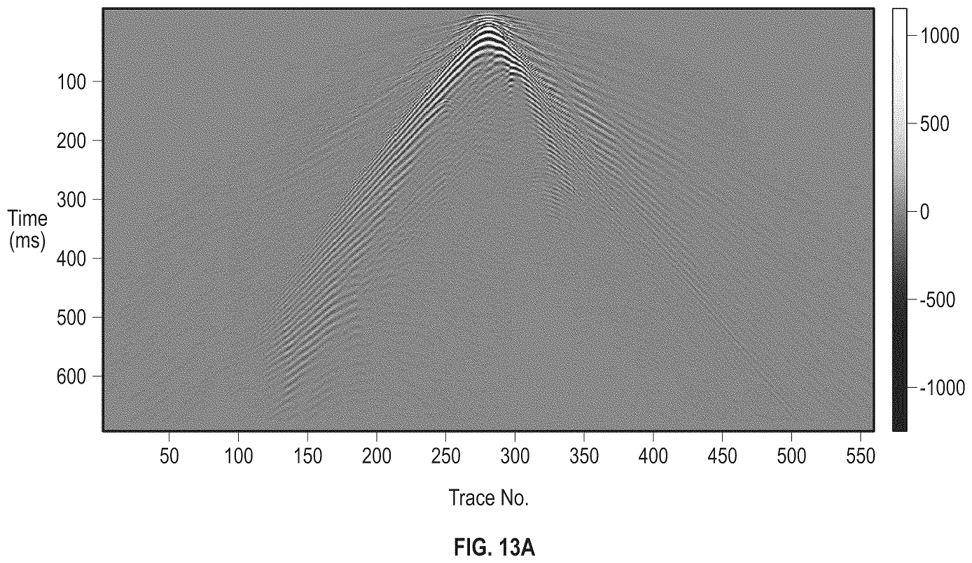

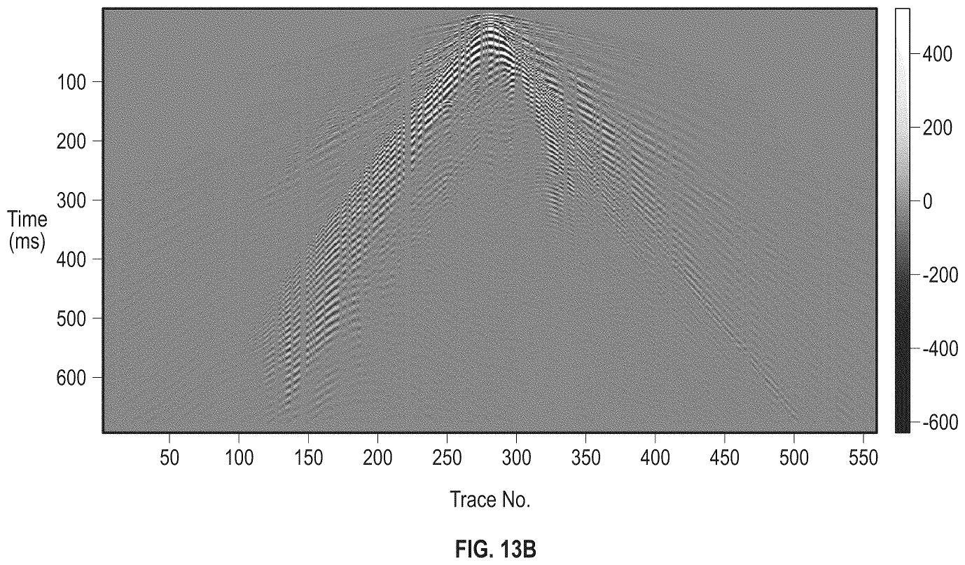

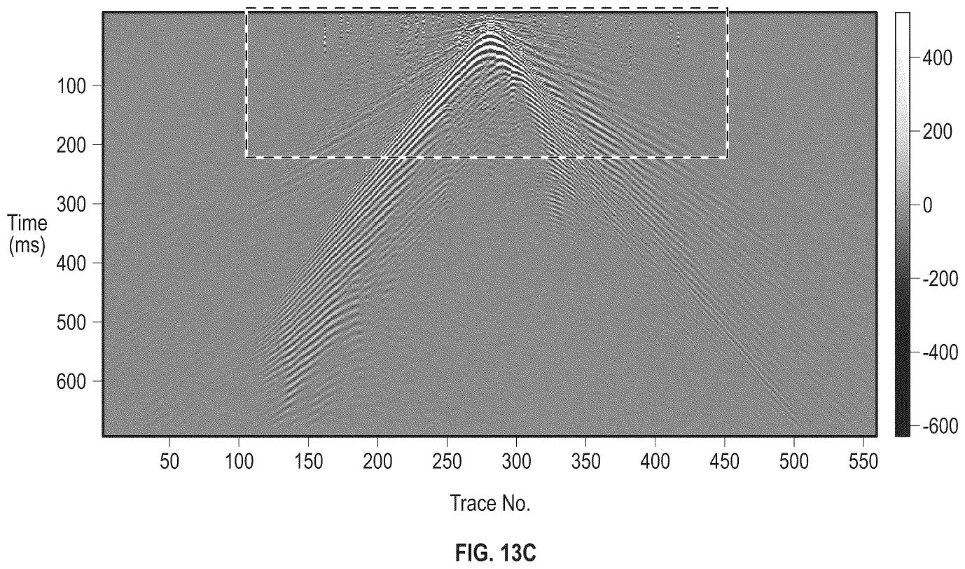

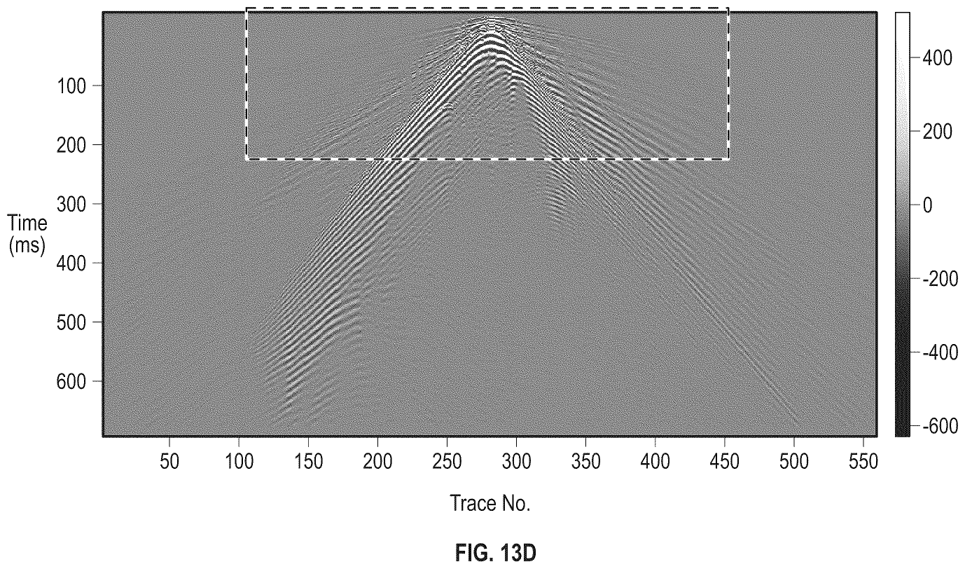

FIGS. 13A-13D present another application of the methodology, this time to a seismic dataset. For this 2D seismic data example, the novel method employs a non-local means denoising method to tweak the initial values.

In FIG. 13A, an original seismic dataset is presented. FIG. 13B shows the sparse input dataset, with 30% of the traces from the original seismic dataset randomly removed. FIG. 13C displays the conventional CP-reconstructed result. As with the results in FIGS. 7 and 11, ringing noise is evident. FIG. 13D shows the reconstruction using the novel CP method. The improvement in data quality is highlighted by the red box. The results can be seen to be less noisy.

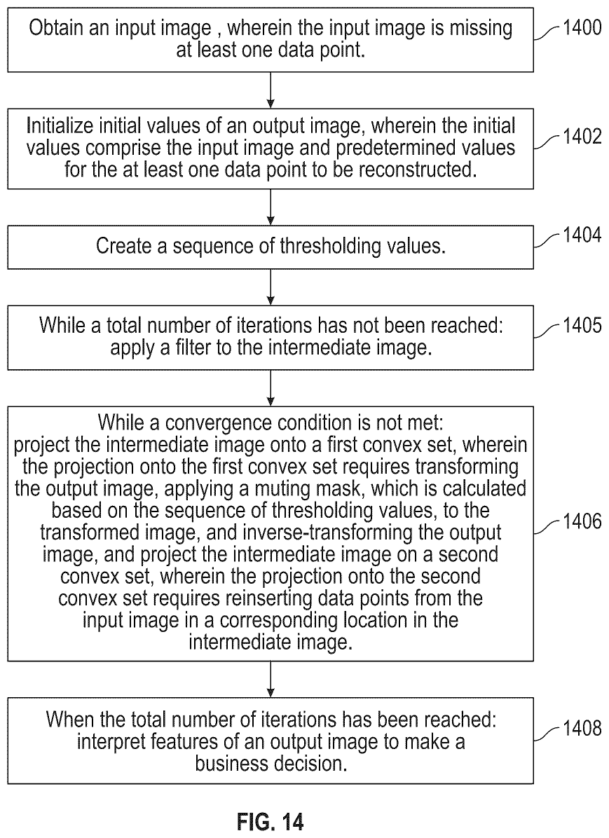

FIG. 14 presents the workflow of the method. In Step 1400, an input image is obtained. The input image is represented on a regular lattice and is missing some portion of data. In Step 1402, an intermediate image is created by copying the input image. The data points that are missing values on the lattice of the intermediate image are initialized to initial values. The intermediate image will pass through all the steps of the method, including tweaking steps, and will eventually be returned to a user at the end of the algorithm. For the examples presented here, the initial values are all zero, but this is not a limitation of the method; any set of initial values may be used. Through the method described above, the missing values will be replaced with an improved set of values by the projections onto convex sets A and B. The non-missing values may also be modified by the novel CP method through the tweaking operation with a filter, as described above.

In Step 1404, a sequence of thresholding coefficients is created, one for each iteration of the method. Each value of the sequence of thresholding coefficients is a value below which a data point in the transformed domain is set to zero during the projection onto convex set B.

In Step 1405, a tweaking operation is performed on the intermediate image. The tweaking operation may take the form of a filter. In the examples presented above, the filter was either a Gaussian filter or a non-local mean denoising technique. The Gaussian filter is applied through a digital filtering process with a convolution kernel. Other tweaking operations may be used, such as those mentioned above. The tweaking operation is a global operation, in that it affects all data points in the intermediate image, as opposed to a subset of data points, as in the projections onto convex sets A and B.

In Step 1406, while a convergence criterion is not met and a maximum number of iterations has not been reached, the method first projects the intermediate image onto a first convex set B. This projection onto a first convex set requires a transform of the intermediate image to another domain-in this case, the Fourier domain. The thresholding mask is applied to the data values in the domain, setting those below the current thresholding value to zero. The intermediate image is then inverse-transformed back to the original domain. Next, the intermediate image is projected onto a second convex set A by reinserting the data values from the original input image into their corresponding locations in the intermediate image. By this process, the intermediate image will look the same as the input image, except the missing data locations will now have values. A convergence criterion is then tested wherein the criterion requires that a norm of a difference between the intermediate image at a current iteration and at a previous iteration be less than a constant multiplied by the norm of the intermediate image at the previous iteration. This is not a limitation, however, as other convergence criteria may also be used.

In Step 1408, when the total number of iterations has been reached, the features of the output image will be interpreted. The goal of the interpretation will depend on the type of image but will affect an operational decision. In the case of a seismic image, the interpretation may be used for locating geologic features that contain hydrocarbons, and then drilling based on the location.

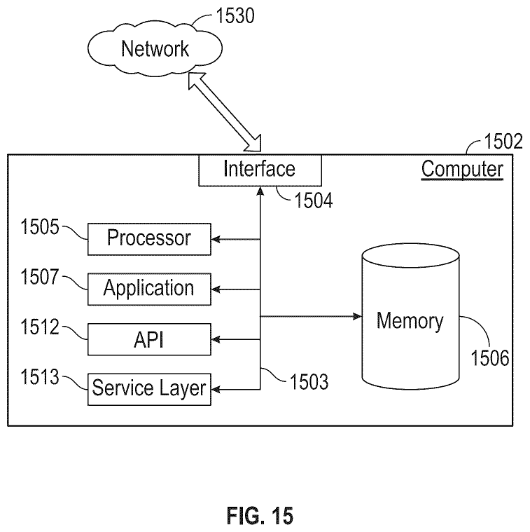

FIG. 15 depicts a block diagram of a such a computer system used to provide computational functionalities associated with described algorithms, methods, functions, processes, flows, and procedures as described in this disclosure, according to one or more embodiments. The illustrated computer (1502) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. The illustrated computer (1502) may include graphics processing units (GPUs). Additionally, the computer (1502) may include an input device, such as a keypad, keyboard, touch screen, or other device that can accept user information, and an output device that conveys information associated with the operation of the computer (1502), including digital data, visual, or audio information (or a combination of information), or a GUI.

The computer (1502) can serve in a role as a client, network component, a server, a database or other persistency, or any other component (or a combination of roles) of a computer system for performing the subject matter described in the instant disclosure. The illustrated computer (1502) is communicably coupled with a network (1530). In some implementations, one or more components of the computer (1502) may be configured to operate within environments, including cloud-computing-based, local, global, or other environment (or a combination of environments).

At a high level, the computer (1502) is an electronic computing device operable to receive, transmit, process, store, or manage data and information associated with the described subject matter. According to some implementations, the computer (1502) may also include or be communicably coupled with an application server, e-mail server, web server, caching server, streaming data server, business intelligence (BI) server, or other server (or a combination of servers).

The computer (1502) can receive requests over a network (1530) from a client application (for example, executing on another computer (1502)) and responding to the received requests by processing the said requests in an appropriate software application. In addition, requests may also be sent to the computer (1502) from internal users (for example, from a command console or by other appropriate access method), external or third-parties, other automated applications, as well as any other appropriate entities, individuals, systems, or computers.

Each of the components of the computer (1502) can communicate using a system bus (1503). In some implementations, any or all of the components of the computer (1502), both hardware or software (or a combination of hardware and software), may interface with each other or the interface (1504) (or a combination of both) over the system bus (1503) using an application programming interface (API) (1512) or a service layer (1513) (or a combination of the API (1512) and service layer (1513)). The API (1512) may include specifications for routines, data structures, and object classes. The API (1512) may be either computer-language independent or dependent and refer to a complete interface, a single function, or even a set of APIs. The service layer (1513) provides software services to the computer (1502) or other components (whether or not illustrated) that are communicably coupled to the computer (1502). The functionality of the computer (1502) may be accessible for all service consumers using this service layer. Software services, such as those provided by the service layer (1513), provide reusable, defined business functionalities through a defined interface. For example, the interface may be software written in JAVA, C++, or other suitable language providing data in extensible markup language (XML) format or another suitable format. While illustrated as an integrated component of the computer (1502), alternative implementations may illustrate the API (1512) or the service layer (1513) as stand-alone components in relation to other components of the computer (1502) or other components (whether or not illustrated) that are communicably coupled to the computer (1502). Moreover, any or all parts of the API (1512) or the service layer (1513) may be implemented as child or sub-modules of another software module, enterprise application, or hardware module without departing from the scope of this disclosure.

The computer (1502) includes an interface (1504). Although illustrated as a single interface (1504) in FIG. 15, two or more interfaces (1504) may be used according to particular needs, desires, or particular implementations of the computer (1502). The interface (1504) is used by the computer (1502) for communicating with other systems in a distributed environment that are connected to the network (1530). Generally, the interface (1504) includes logic encoded in software or hardware (or a combination of software and hardware) and operable to communicate with the network (1530). More specifically, the interface (1504) may include software supporting one or more communication protocols associated with communications such that the network (1530) or interface's hardware is operable to communicate physical signals within and outside of the illustrated computer (1502).

The computer (1502) includes at least one computer processor (1505). Although illustrated as a single computer processor (1505) in FIG. 15, two or more processors may be used according to particular needs, desires, or particular implementations of the computer (1502). Generally, the computer processor (1505) executes instructions and manipulates data to perform the operations of the computer (1502) and any algorithms, methods, functions, processes, flows, and procedures as described in the instant disclosure.

The computer (1502) also includes a memory (1506) that holds data for the computer (1502) or other components (or a combination of both) that can be connected to the network (1530). For example, memory (1506) can be a database storing data consistent with this disclosure. Although illustrated as a single memory (1506) in FIG. 15, two or more memories may be used according to particular needs, desires, or particular implementations of the computer (1502) and the described functionality. While memory (1506) is illustrated as an integral component of the computer (1502), in alternative implementations, memory (1506) can be external to the computer (1502). The memory (1506) may include a non-transitory computer readable medium that stores instructions executable by a computer processor.

The application (1507) is an algorithmic software engine providing functionality according to particular needs, desires, or particular implementations of the computer (1502), particularly with respect to functionality described in this disclosure. For example, the application (1507) can serve as one or more components, modules, applications, etc. Further, although illustrated as a single application (1507), the application (1507) may be implemented as multiple applications (1507) on the computer (1502). In addition, although illustrated as integral to the computer (1502), in alternative implementations, the application (1507) can be external to the computer (1502).

There may be any number of computers (1502) associated with, or external to, a computer system containing computers (1502), wherein each computer (1502) communicates over network (1530). Further, the term “client,” “user,” and other appropriate terminology may be used interchangeably as appropriate without departing from the scope of this disclosure. Moreover, this disclosure contemplates that many users may use one computer (1502), or that one user may use multiple computers (1502).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of data reconstruction, comprising:
obtaining an input image, wherein the input image is missing at least one data point;
initializing initial values of an intermediate image, wherein the initial values comprise the input image and predetermined values for the at least one data point to be reconstructed;
creating a sequence of thresholding values;
while a total number of iterations has not been reached:
applying a filter to the intermediate image, and
while a convergence condition is not met:
projecting the intermediate image onto a first convex set, wherein the projection onto the first convex set requires transforming the intermediate image, applying a muting mask, calculated based on the sequence of thresholding values, to the intermediate image, and inverse-transforming the intermediate image, and
projecting the intermediate image on a second convex set, wherein the projection onto the second convex set requires reinserting data points from the input image in a corresponding location in the intermediate image; and
when the total number of iterations has been reached: recording the intermediate image as a reconstructed output image and interpreting features of the reconstructed output image to make an operational decision.

2. The method of claim 1, wherein transforming the intermediate image utilizes a Fourier transform and inverse-transforming the intermediate image utilizes an inverse Fourier transform.

3. The method of claim 1, wherein initializing the initial values comprises initializing the initial values to zero.

4. The method of claim 1, wherein the input image is a seismic image.

5. The method of claim 1, wherein the sequence of thresholding values is non-increasing.

6. The method of claim 1, wherein the convergence condition requires that a norm of a difference between the intermediate image at a current iteration and at a previous iteration be less than a constant multiplied by the norm of the intermediate image at the previous iteration.

7. The method of claim 1, wherein the filter is a Gaussian filter.

8. The method of claim 4, wherein interpreting the features of the intermediate image comprises interpreting geological features.

9. The method of claim 8, wherein the operational decision is to drill for hydrocarbons.

10. A non-transitory computer readable medium storing instructions executable by a computer processor, the instructions comprising functionality for:
initializing initial values of an intermediate image, wherein the initial values comprise an input image missing at least one data point and predetermined values for the at least one data point to be reconstructed;
creating a sequence of thresholding values;
while a total number of iterations has not been reached:
applying a filter to the intermediate image,
using the sequence of thresholding values to update a muting mask, and
while a convergence condition is not met:
projecting the intermediate image onto a first convex set, wherein the projection onto the first convex set requires transforming the intermediate image, applying the muting mask, and inverse-transforming the intermediate image, and
projecting the intermediate image on a second convex set, wherein the projection onto the second convex set requires reinserting data points from the input image in a corresponding location in the intermediate image; and
when the total number of iterations has been reached: recording the intermediate image as a reconstructed output image and interpreting features of the reconstructed output image to make an operational decision.

11. The non-transitory computer readable medium storing instructions executable by a computer processor of claim 10, wherein transforming the intermediate image utilizes a Fourier transform and inverse-transforming the intermediate image utilizes an inverse Fourier transform.

12. The non-transitory computer readable medium storing instructions executable by a computer processor of claim 10, wherein initializing the initial values comprises initializing the initial values to zero.

13. The non-transitory computer readable medium storing instructions executable by a computer processor of claim 10, wherein the input image is a seismic image.

14. The non-transitory computer readable medium storing instructions executable by a computer processor of claim 10, wherein the sequence of thresholding values is non-increasing.

15. The non-transitory computer readable medium storing instructions executable by a computer processor of claim 10, wherein the convergence condition requires that a norm of a difference between the intermediate image at a current iteration and at a previous iteration be less than a constant multiplied by the norm of the intermediate image at the previous iteration.

16. The non-transitory computer readable medium storing instructions executable by a computer processor of claim 10, wherein the filter is a Gaussian filter.

17. A system, comprising:
an input image; and
a computer system, configured to:
initialize initial values of an intermediate image, wherein the initial values comprise the input image and predetermined values for at least one data point to be reconstructed,
create a sequence of thresholding values,
while a total number of iterations has not been reached:
apply a filter to the intermediate image,
use the sequence of thresholding values to update a muting mask,
while a convergence condition is not met:
project the intermediate image onto a first convex set, wherein the projection onto the first convex set requires transforming the intermediate image, applying the muting mask, and inverse-transforming the intermediate image, and
project the intermediate image on a second convex set, wherein the projection onto the second convex set requires reinserting data points from the input image in a corresponding location in the intermediate image, and
when the total number of iterations has been reached:
recording the intermediate image as a reconstructed output image and interpreting features of the reconstructed output image to make an operational decision.

18. The system of claim 17, wherein the input image is a seismic image.

19. The system of claim 17, wherein the sequence of thresholding values is non-increasing.

20. The system of claim 17, wherein the convergence condition requires that a norm of a difference between the intermediate image at a current iteration and at a previous iteration be less than a constant multiplied by the norm of the intermediate image at the previous iteration.
